(19) United States
(12) Patent Application Publication
(10) Pub. No.: US 2024/0142610 A1
(43) Pub. Date: May 2, 2024

(54) EXPLORATION METHOD, EXPLORATION SYSTEM, CONTROL DEVICE, AND PROGRAM

(71) Applicant: NIPPON TELEGRAPH AND TELEPHONE CORPORATION, Tokyo (JP)

(72) Inventors: Daisaku NISHIYAMA, Tokyo (JP); Kenji HIYOSHI, Tokyo (JP); Daiki KOBAYASHI, Tokyo (JP); Mizuki TABATA, Tokyo (JP)

(73) Assignee: NIPPON TELEGRAPH AND TELEPHONE CORPORATION, Tokyo (JP)

(21) Appl. No.: 18/280,468

(22) PCT Filed: Mar. 8, 2021
(86) PCT No.: PCT/JP2021/008917

§ 371 Date: Sep. 5, 2023

(51) Int. Cl. G01S 13/88; G01S 7/03; G01S 7/41

(52) U.S. Cl. CPC G01S 13/885; G01S 7/03; G01S 7/411

(57) ABSTRACT

An exploration method according to the present disclosure includes: a step (S11) of disposing, in a pipeline (PL) that allows a plurality of manholes (MH) to be interconnected, an electromagnetic wave receiving/transmitting device (1) that transmits an electromagnetic wave and receives a reflected electromagnetic wave that is a reflected wave of the electromagnetic wave; a step (S13) of transmitting the electromagnetic wave; a step (S14) of receiving the reflected electromagnetic wave that is the reflected wave of the electromagnetic wave; and a step (S18) of calculating an intensity distribution of the reflected electromagnetic wave on the basis of an intensity of the reflected electromagnetic wave and a round-trip propagation time from when the electromagnetic wave is transmitted to when the reflected electromagnetic wave is received.

### TECHNICAL FIELD

The present disclosure relates to an exploration method, an exploration system, a control device, and a program.

### BACKGROUND ART

In order to prevent sagging of a road and ensure safety of underground social infrastructure equipment, it is necessary to accurately identify positions of cavities and buried objects in an underground space. Especially in an underground space in an urban area crowded with structures, it is required to more accurately identify the positions of cavities and buried objects. Thus, for the purpose of identifying the positions of cavities and buried objects periodically or before construction of the underground space, it is known to identify the positions of cavities and buried objects by, for example, emitting an electromagnetic wave from the ground into the ground and receiving a reflected wave of the electromagnetic wave as described in Non Patent Literature 1 and Non Patent Literature 2.

### CITATION LIST

### Non Patent Literature

Non Patent Literature 1: “Report from Ground-Penetrating Radar Technology Survey Study Group”, Ground-Penetrating Radar Technology Survey Study Group, March 2017
Non Patent Literature 2: “Kanto Geotechnical Consultants Association | Chamber of Technology_News Articles | Technology News 78: Ground-Penetrating Radar Exploration”, [online], [retrieved on Feb. 9, 2021], Internet <URL:http://www.kanto-geo.or.jp/various/technologyRoom/TR2_wotn_78_1.html>

### SUMMARY OF INVENTION

### Technical Problem

However, in such a technology, in a case where there is an obstacle such as a railway track on the ground, the obstacle may prevent transmission of an electromagnetic wave into the ground, and make it difficult to identify the positions of underground cavities and buried objects.

It is an object of the present disclosure made in view of problems as described above to provide an exploration method, an exploration system, a control device, and a program that allow for identifying the positions of underground cavities and buried objects even in a case where there is an obstacle on the ground.

### Solution to Problem

In order to solve the above problems, an exploration method according to the present disclosure includes: a step of disposing, in a pipeline that allows a plurality of manholes to be interconnected, an electromagnetic wave receiving/transmitting device that transmits an electromagnetic wave and receives a reflected electromagnetic wave that is a reflected wave of the electromagnetic wave; a step of transmitting the electromagnetic wave; a step of receiving the reflected electromagnetic wave that is the reflected wave of the electromagnetic wave; and a step of calculating an intensity distribution of the reflected electromagnetic wave on the basis of an intensity of the reflected electromagnetic wave and a round-trip propagation time from when the electromagnetic wave is transmitted to when the reflected electromagnetic wave is received.

Furthermore, in order to solve the above problems, an exploration system according to the present disclosure includes: an electromagnetic wave receiving/transmitting device that transmits an electromagnetic wave in a pipeline that allows a plurality of manholes to be interconnected and receives a reflected electromagnetic wave that is a reflected wave of the electromagnetic wave; and a control device that calculates an intensity distribution of the reflected electromagnetic wave on the basis of an intensity of the reflected electromagnetic wave and a round-trip propagation time from when the electromagnetic wave is transmitted to when the reflected electromagnetic wave is received.

Furthermore, in order to solve the above problems, a control device according to the present disclosure is configured to calculate an intensity distribution of a reflected electromagnetic wave, on the basis of an intensity of the reflected electromagnetic wave that is a reflected wave of an electromagnetic wave transmitted from an electromagnetic wave receiving/transmitting device disposed in a pipeline that allows a plurality of manholes to be interconnected, and a round-trip propagation time from when the electromagnetic wave is transmitted to when the reflected wave of the electromagnetic wave is received.

Furthermore, in order to solve the above problems, a program according to the present disclosure causes a computer to function as the control device described above.

### Advantageous Effects of Invention

According to the exploration method, the exploration system, the control device, and the program according to the present disclosure, it is possible to identify the positions of underground cavities and buried objects even in a case where there is an obstacle on the ground.

### BRIEF DESCRIPTION OF DRAWINGS

FIG. 1 is an overall schematic diagram of an exploration system according to a first embodiment.

FIG. 2 is a diagram illustrating an example of a state in which an electromagnetic wave receiving/transmitting device illustrated in FIG. 1 is disposed in an underground pipeline.

FIG. 3 illustrates an example of a distribution map illustrating an intensity distribution of an electromagnetic wave displayed by a display unit illustrated in FIG. 1.

FIG. 4 is a sequence diagram illustrating an example of an exploration method by the exploration system illustrated in FIG. 1.

FIG. 5 is an overall schematic diagram of an exploration system according to a second embodiment.

FIG. 6 is a diagram illustrating an example of a state in which an electromagnetic wave receiving/transmitting device illustrated in FIG. 5 is disposed in an underground pipeline.

FIG. 7 is a sequence diagram illustrating an example of an exploration method by the exploration system illustrated in FIG. 5.

FIG. 8 is an overall schematic diagram of an exploration system according to a third embodiment.

FIG. 9 is a diagram illustrating an example of a state in which an electromagnetic wave receiving/transmitting device illustrated in FIG. 8 is disposed in an underground pipeline.

FIG. 10A is a sequence diagram illustrating an example of an exploration method by the exploration system illustrated in FIG. 8.

FIG. 10B is a sequence diagram illustrating an example of the exploration method by the exploration system illustrated in FIG. 8.

FIG. 11 is an overall schematic diagram of an exploration system according to a fourth embodiment.

FIG. 12 is a diagram illustrating an example of a state in which an electromagnetic wave receiving/transmitting device illustrated in FIG. 11 is disposed in an underground pipeline.

FIG. 13 illustrates an example of a distribution map illustrating an intensity distribution of an electromagnetic wave displayed by a display unit of a control device illustrated in FIG. 11.

FIG. 14A is a sequence diagram illustrating an example of an exploration method by the exploration system illustrated in FIG. 11.

FIG. 14B is a sequence diagram illustrating an example of the exploration method by the exploration system illustrated in FIG. 11.

FIG. 15 is a hardware block diagram of the control device according to the third and fourth embodiments.

### DESCRIPTION OF EMBODIMENTS

First, embodiments of the present disclosure will be described with reference to the drawings.

### First Embodiment

<Functional Configuration of Exploration System>

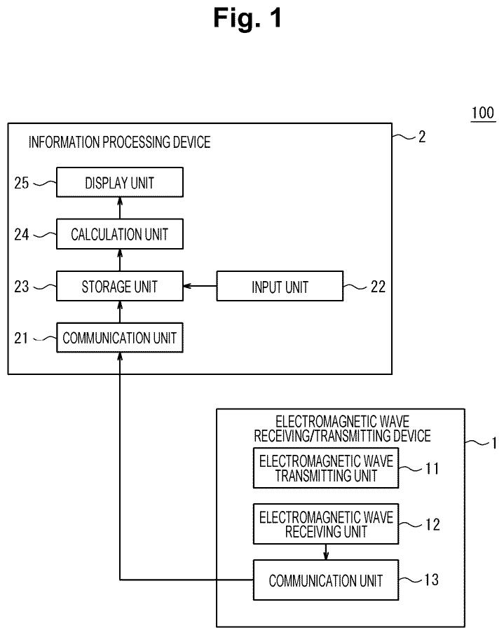

An entire configuration of a first embodiment will be described with reference to FIG. 1. FIG. 1 is a schematic diagram of an exploration system 100 according to the first embodiment.

The exploration system 100 according to the first embodiment includes an electromagnetic wave receiving/transmitting device 1 and an information processing device 2. The electromagnetic wave receiving/transmitting device 1 and the information processing device 2 mutually transmit and receive information via a wired or wireless communication network.

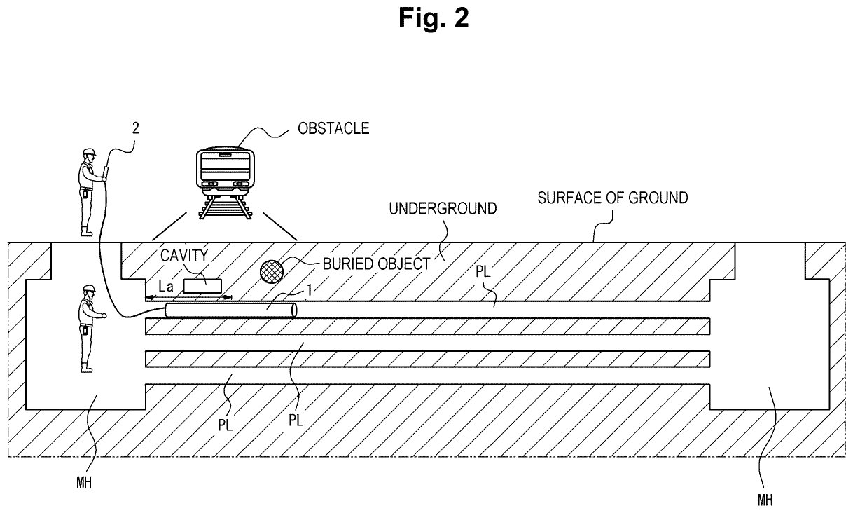

The electromagnetic wave receiving/transmitting device 1 transmits an electromagnetic wave, and receives a reflected electromagnetic wave that is a reflected wave of the electromagnetic wave. The electromagnetic wave receiving/transmitting device 1 is, for example, a probe of an electromagnetic wave explorer, and can be a borehole radar. As illustrated in FIG. 2, the electromagnetic wave receiving/transmitting device 1 is disposed in a pipeline PL that is provided under the ground and allows a plurality of manholes MH to be interconnected. The manhole MH is equipment that defines an underground space into which a worker enters to perform maintenance on an infrastructure facility for water supply, sewer, electricity, gas, communication, or the like. The pipeline PL is formed with the use of a non-metal material, for example, vinyl chloride.

Specifically, a worker disposes the electromagnetic wave receiving/transmitting device 1 in the pipeline PL by inserting the electromagnetic wave receiving/transmitting device 1 from one end (hereinafter referred to as a “pipeline inlet”) side (in the example in FIG. 2, the side facing the manhole MH on the left side) of the pipeline PL. The electromagnetic wave receiving/transmitting device 1 may be disposed again in the pipeline PL so as to be moved by a worker.

As illustrated in FIG. 1, the electromagnetic wave receiving/transmitting device 1 includes an electromagnetic wave transmitting unit 11, an electromagnetic wave receiving unit 12, and a communication unit 13. The electromagnetic wave transmitting unit 11 and the electromagnetic wave receiving unit 12 include an antenna. The communication unit 13 is constituted by a communication interface.

When a worker inputs a drive command, the electromagnetic wave transmitting unit 11 transmits an electromagnetic wave. The electromagnetic wave transmitted by the electromagnetic wave transmitting unit 11 is in a frequency band of 50 MHz to 4.5 GHz. The drive command may be input to the electromagnetic wave receiving/transmitting device 1, or may be input to the information processing device 2 and then transmitted from the information processing device 2 to the electromagnetic wave receiving/transmitting device 1.

The electromagnetic wave receiving unit 12 receives an electromagnetic wave. Specifically, the electromagnetic wave receiving unit 12 receives a reflected electromagnetic wave that is a reflected wave of the electromagnetic wave transmitted by the electromagnetic wave transmitting unit 11.

The communication unit 13 transmits, to the information processing device 2 via a wired or wireless communication network, electromagnetic wave information indicating an intensity of the reflected electromagnetic wave received by the electromagnetic wave receiving unit 12 and a round-trip propagation time of the electromagnetic wave at each point in time. The round-trip propagation time is the time from when the electromagnetic wave receiving/transmitting device 1 transmits the electromagnetic wave to when the electromagnetic wave receiving/transmitting device 1 receives the reflected electromagnetic wave that is the reflected wave of the electromagnetic wave. In a configuration in which the communication unit 13 transmits the electromagnetic wave information to the information processing device 2 via a wired communication network, a worker can take out the electromagnetic wave receiving/transmitting device 1 from the pipeline PL by pulling, from the pipeline inlet side, a communication cable constituting the wired communication network after completion of an exploration. Note that the above-described “point in time” may be the time elapsed since a base point in time, or may be the time of day. The base point in time is, for example, the point in time when a drive command is input to the information processing device 2.

The information processing device 2 is, for example, a main body of an electromagnetic wave explorer. The information processing device 2 includes a communication unit 21, an input unit 22, a storage unit 23, a calculation unit 24, and a display unit 25. The communication unit 21 is constituted by a communication interface. The storage unit 23 is constituted by, for example, a memory such as a semiconductor memory, a magnetic memory, or an optical memory. The calculation unit 24 constitutes a control unit (controller). The control unit may be constituted by dedicated hardware such as an application specific integrated circuit (ASIC) or a field-programmable gate array (FPGA), may be constituted by a processor, or may include both dedicated hardware and a processor. The display unit 25 is constituted by a display interface such as a liquid crystal panel or an organic EL.

The communication unit 21 receives the electromagnetic wave information from the communication unit 13 of the electromagnetic wave receiving/transmitting device 1 via a wired or wireless communication network. In a configuration in which a drive command for the electromagnetic wave receiving/transmitting device 1 is input to the information processing device 2, the communication unit 21 transmits the input drive command to the electromagnetic wave receiving/transmitting device 1.

The input unit 22 receives an input of movement distance information indicating a movement distance La by which the electromagnetic wave receiving/transmitting device 1 has been moved from a reference position in the pipeline PL. The reference position is an optional predetermined position in the pipeline PL, and is the pipeline inlet in the example illustrated in FIG. 2. The movement distance information may be input by a worker or may be input by any other method. In a configuration in which the movement distance information is input by a worker, the worker may measure the movement distance La at each point in time by visually observing a scale provided on a cord-shaped member attached to the electromagnetic wave receiving/transmitting device 1.

The storage unit 23 stores the electromagnetic wave information received by the communication unit 21. The storage unit 23 stores the movement distance information, the input of which has been received by the input unit 22.

The calculation unit 24 calculates an intensity distribution of the reflected electromagnetic wave on the basis of the intensity of the reflected electromagnetic wave and the round-trip propagation time from when the electromagnetic wave is transmitted to when the reflected electromagnetic wave is received. Hereinafter, processing in which the calculation unit 24 calculates the intensity distribution will be described in detail.

The calculation unit 24 calculates a distance (electromagnetic wave reaching distance) Lb from the electromagnetic wave receiving/transmitting device 1 to the position where the electromagnetic wave has been reflected on the basis of the round-trip propagation time of the electromagnetic wave at each point in time included in the electromagnetic wave information. Specifically, the calculation unit 24 calculates the electromagnetic wave reaching distance Lb on the basis of a propagation velocity and the round-trip propagation time of the electromagnetic wave. More specifically, the calculation unit 24 calculates the electromagnetic wave reaching distance Lb as (electromagnetic wave propagation velocity v×round-trip propagation time)/2. Here, the electromagnetic wave propagation velocity v is calculated by the following Formula (1). In Formula (1), C is the velocity of light in vacuum, and εₛ is a relative permittivity of a medium through which the electromagnetic wave propagates.

$$[ Math . 1 ]$$

$$v = \frac{C}{\sqrt{{ε}_{s}}} \qquad ( 1 )$$

Then, the calculation unit 24 calculates the intensity distribution of the electromagnetic wave, which shows a relationship between the electromagnetic wave reaching distance Lb and the intensity of the reflected electromagnetic wave, on the basis of the electromagnetic wave reaching distance Lb at each point in time calculated as described above and the intensity of the reflected electromagnetic wave at each point in time included in the electromagnetic wave information.

At this time, the calculation unit 24 may calculate the intensity distribution of the electromagnetic wave also on the basis of the movement distance La by which the electromagnetic wave receiving/transmitting device 1 has been moved from the reference position in the pipeline PL. Specifically, also on the basis of the movement distance La indicated by the movement distance information, the calculation unit 24 may calculate the intensity distribution of the electromagnetic wave, which shows the relationship among the movement distance La, the electromagnetic wave reaching distance Lb, and the intensity of the reflected electromagnetic wave at each point in time.

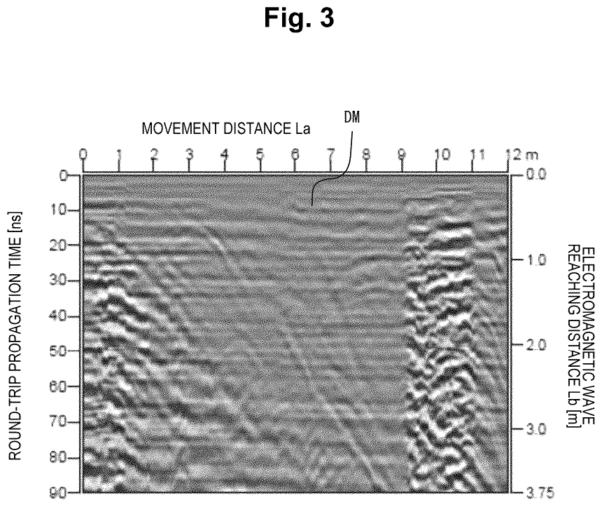

For example, the calculation unit 24 may generate a of the reflected electromagnetic wave with respect to the electromagnetic wave reaching distance Lb and the movement distance La as illustrated in FIG. 3. Specifically, the calculation unit 24 may generate a distribution map DM in which the intensity of the reflected electromagnetic wave is shown with brightness at a portion corresponding to the movement distance La and the electromagnetic wave reaching distance Lb.

The display unit 25 displays the intensity distribution of the reflected electromagnetic wave calculated by the calculation unit 24. In a configuration in which the calculation unit 24 generates a distribution map DM as described above, the display unit 25 may display the distribution map DM generated by the calculation unit 24.

<Exploration Method>

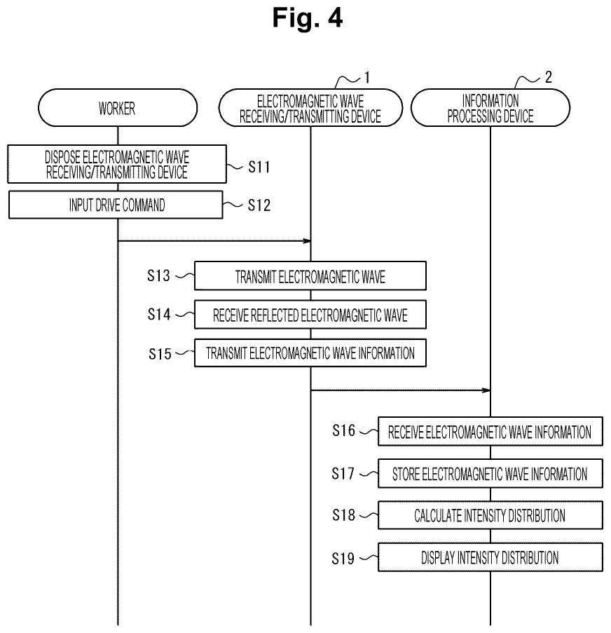

Here, an exploration method according to the first embodiment will be described with reference to FIG. 4. FIG. 4 is a sequence diagram illustrating an example of the exploration method according to the first embodiment.

In step S11, a worker disposes, in the pipeline PL that allows the plurality of manholes MH to be interconnected, the electromagnetic wave receiving/transmitting device 1 that transmits an electromagnetic wave and receives a reflected electromagnetic wave that is a reflected wave of the electromagnetic wave.

In step S12, the worker inputs a drive command for driving the electromagnetic wave receiving/transmitting device 1.

In step S13, the electromagnetic wave receiving/transmitting device 1 transmits an electromagnetic wave on the basis of the drive command input by the worker.

In step S14, the electromagnetic wave receiving/transmitting device 1 receives a reflected electromagnetic wave that is a reflected wave of the electromagnetic wave.

In step S15, the communication unit 13 transmits electromagnetic wave information to the information processing device 2 via a wired or wireless communication network.

In step S16, the information processing device 2 receives the electromagnetic wave information.

In step S17, the information processing device 2 stores the electromagnetic wave information.

In step S18 at an optional timing thereafter, the information processing device 2 calculates the intensity distribution of the reflected electromagnetic wave on the basis of the intensity of the reflected electromagnetic wave indicated by the electromagnetic wave information. Furthermore, the information processing device 2 may generate a distribution map DM indicating the intensity distribution of the reflected electromagnetic wave.

In step S19, the information processing device 2 displays the intensity distribution of the electromagnetic wave. In a configuration in which the information processing device 2 generates a distribution map DM, the information processing device 2 may display the distribution map DM.

At any timing after step 14, the worker may dispose again the electromagnetic wave receiving/transmitting device 1 in the pipeline PL so as to move the electromagnetic wave receiving/transmitting device 1. In this case, the exploration system 100 returns to step S13 and repeats the processing.

Furthermore, at any timing after step S11 and before step S18, the worker may input, to the information processing device 2, movement distance information indicating the movement distance La, which is the distance from the reference position to the electromagnetic wave receiving/transmitting device 1, and then the information processing device 2 may receive the input of the movement distance information. In such a configuration, in step S19, the information processing device 2 calculates the intensity distribution of the reflected electromagnetic wave also on the basis of the movement distance La by which the electromagnetic wave receiving/transmitting device 1 has been moved from the reference position in the pipeline PL at each point in time.

As described above, in the exploration system 100 according to the first embodiment, the electromagnetic wave receiving/transmitting device 1 that transmits an electromagnetic wave and receives a reflected electromagnetic wave that is a reflected wave of the electromagnetic wave is disposed in the pipeline PL that allows the plurality of manholes MH to be interconnected. Thus, even in a case where there is an obstacle on the ground, it is possible to identify the positions of cavities and buried objects in the ground.

### Second Embodiment

<Functional Configuration of Exploration System>

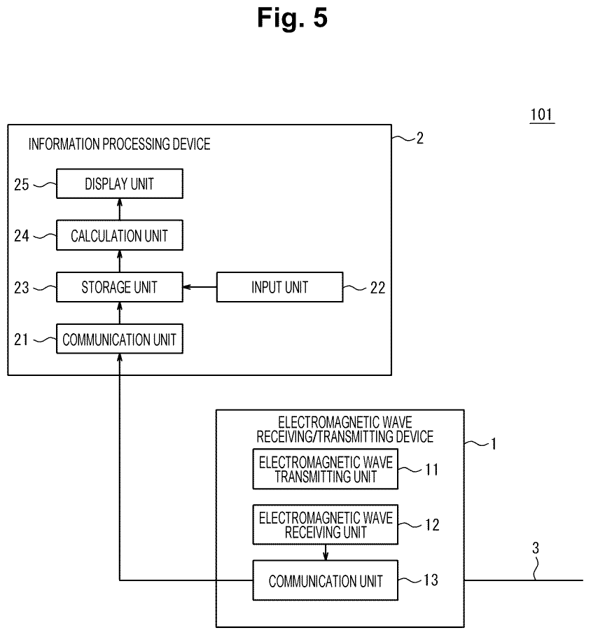

An entire configuration of a second embodiment will be described with reference to FIG. 5. FIG. 5 is a schematic diagram of an exploration system 101 according to the second embodiment. In the second embodiment, the same functional units as those in the first embodiment are denoted by the same reference numerals, and description thereof will be omitted.

The exploration system 101 according to the second embodiment includes an electromagnetic wave receiving/transmitting device 1, an information processing device 2, and a pulling member 3.

One end of the pulling member 3 is fixedly attached to the electromagnetic wave receiving/transmitting device 1. The pulling member 3 is formed with the use of an optional material, and can be in any shape that allows the pulling member 3 to be passed through a pipeline PL in the ground. The pulling member 3 may be, for example, a metal wire.

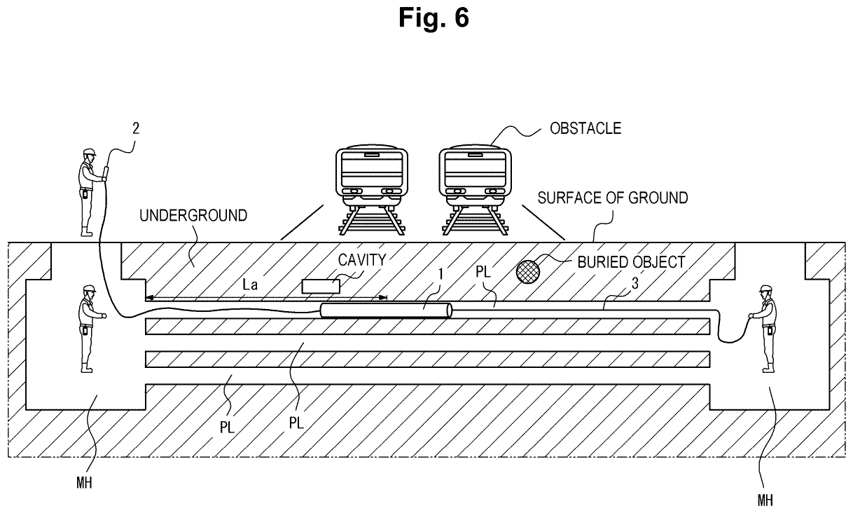

As illustrated in FIG. 6, a worker passes the other end of the pulling member 3 through the pipeline PL from one end (pipeline inlet) to the other end (hereinafter referred to as a “pipeline outlet”) of the pipeline PL, and disposes the electromagnetic wave receiving/transmitting device 1 in the pipeline PL. At this time, a lubricant may be applied to a contact surface of the electromagnetic wave receiving/transmitting device 1 with the pipeline PL. The lubricant is a low friction fluid such as a fluid polymer or oil. Then, the worker moves the electromagnetic wave receiving/transmitting device 1 by pulling the other end of the pulling member 3.

<Exploration Method>

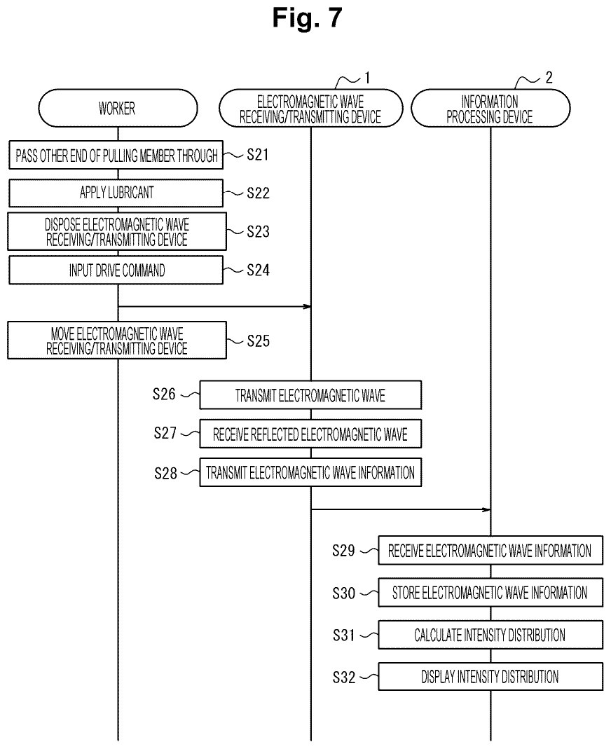

Here, an exploration method according to the second embodiment will be described with reference to FIG. 7. FIG. 7 is a sequence diagram illustrating an example of the exploration method according to the second embodiment.

In step S21, a worker passes the other end of the pulling member 3, the one end of which is fixedly attached to the electromagnetic wave receiving/transmitting device 1, through the pipeline PL.

In step S22, the worker applies a lubricant to the contact surface of the electromagnetic wave receiving/transmitting device 1 with the pipeline PL.

In step S23, the worker disposes, in the pipeline PL, the electromagnetic wave receiving/transmitting device 1 to which the lubricant has been applied.

In step S24, the worker inputs a drive command for driving the electromagnetic wave receiving/transmitting device 1.

In step S25, the worker moves the electromagnetic wave receiving/transmitting device 1 in the pipeline PL by pulling the pulling member 3.

After step S24, the processing in steps S26 to S28 is executed with the electromagnetic wave receiving/transmitting device 1 being moved by the worker. Furthermore, the information processing device 2 executes the processing in steps S29 to S32. The pieces of processing in steps S26 to S32 are the same as the pieces of processing in steps S13 to S19, respectively, in the first embodiment.

Note that the processing in step S22 may not be executed. Furthermore, the processing in step S21 may be executed after the processing in step S22.

As described above, according to the second embodiment, a worker pulls the pulling member 3 having one end attached to the electromagnetic wave receiving/transmitting device 1, and this widens the area in which the electromagnetic wave receiving/transmitting device 1 can be moved as compared with the first embodiment. Thus, the exploration system 101 can identify the positions of cavities, buried objects, or the like in a wider area.

Furthermore, according to the second embodiment, a lubricant is applied to the contact surface of the electromagnetic wave receiving/transmitting device 1 with the pipeline PL, and this allows for a reduction in frictional force between the electromagnetic wave receiving/transmitting device 1 and the pipeline PL, and allows for efficient movement of the electromagnetic wave receiving/transmitting device 1. Thus, the exploration system 101 can efficiently identify the positions of cavities, buried objects, or the like in a wider area.

### Third Embodiment

<Functional Configuration of Exploration System>

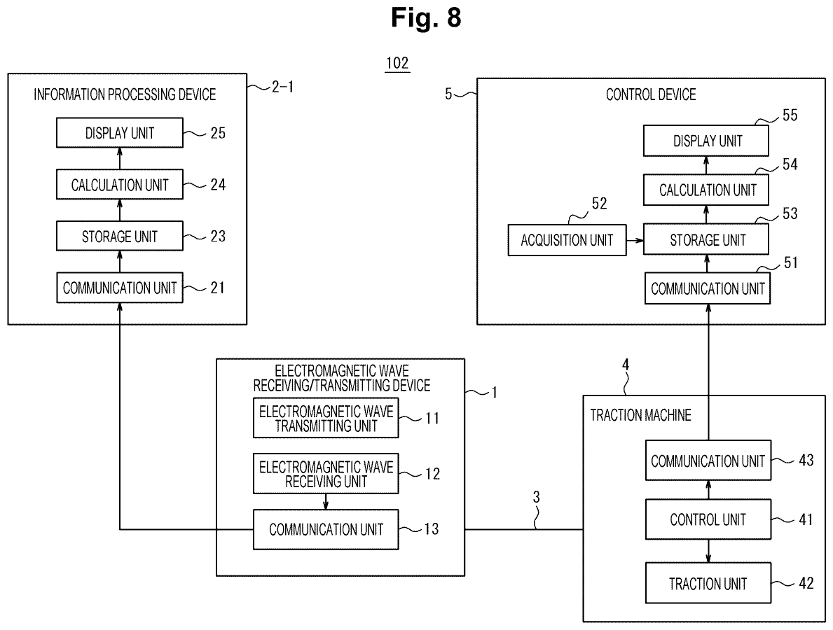

An entire configuration of a third embodiment will be described with reference to FIG. 8. FIG. 8 is a schematic diagram of an exploration system 102 according to the third embodiment. In the third embodiment, the same functional units as those in the second embodiment are denoted by the same reference numerals, and description thereof will be omitted.

The exploration system 102 according to the second embodiment includes an electromagnetic wave receiving/transmitting device 1, an information processing device 2-1, a pulling member 3, a traction machine 4, and a control device 5.

The information processing device 2-1 includes a communication unit 21, a storage unit 23, a calculation unit 24, and a display unit 25. Unlike the information processing device 2 in the first and second embodiments, the information processing device 2-1 in the third embodiment may not include an input unit 22.

The traction machine 4 moves the electromagnetic wave receiving/transmitting device 1 in a pipeline PL that allows a plurality of manholes to be interconnected. The traction machine 4 includes a control unit 41, a traction unit 42, and a communication unit 43. The control unit 41 may be constituted by dedicated hardware such as ASIC or FPGA, may be constituted by a processor, or may include both dedicated hardware and a processor. The traction unit 42 is constituted by a winch or the like capable of pulling the pulling member 3. The communication unit 43 is constituted by a communication interface.

The control unit 41 controls the traction unit 42 so as to move the electromagnetic wave receiving/transmitting device 1 from a reference position in the pipeline PL to a position by a movement distance La at each point in time. For example, the control unit 41 may control the traction unit 42 so that the traction unit 42 exerts traction on the pulling member 3 having one end fixedly attached to the electromagnetic wave receiving/transmitting device 1, from an end on the other side of the pipeline PL (hereinafter referred to as a “pipeline outlet”). Furthermore, the control unit 41 may control the traction unit 42 so as to move the electromagnetic wave receiving/transmitting device 1 at a constant velocity.

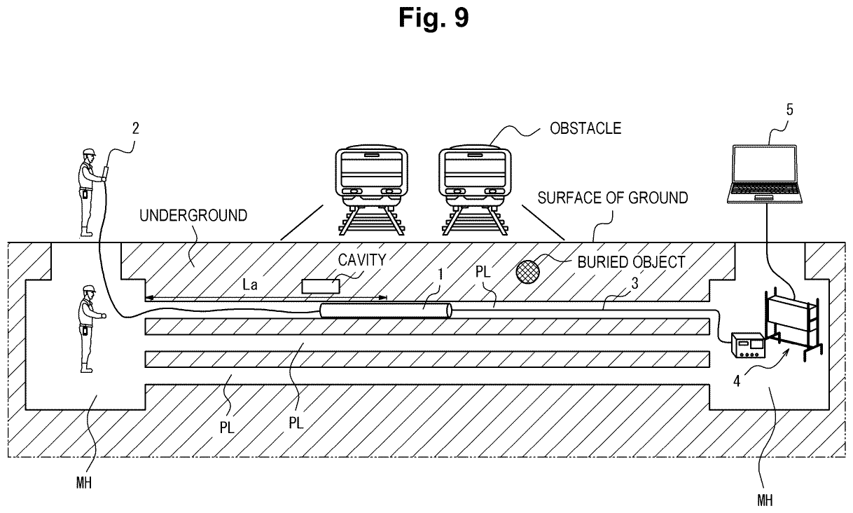

The traction unit 42 moves the electromagnetic wave receiving/transmitting device 1 on the basis of the control of the control unit 41. The traction unit 42 may move the electromagnetic wave receiving/transmitting device 1 at a constant velocity. In this example, the traction unit 42 moves the electromagnetic wave receiving/transmitting device 1 toward the pipeline outlet by exerting, from the pipeline outlet side, traction on the pulling member 3 having one end fixedly attached to the electromagnetic wave receiving/transmitting device 1 as illustrated in FIG. 9. In the example illustrated in FIG. 9, the pipeline outlet is an end of the pipeline PL, the end being on the side facing a manhole MH on the right side.

On the basis of the control of the traction unit 42 by the control unit 41, the communication unit 43 transmits, to the control device 5, movement distance information indicating the movement distance La of the electromagnetic wave receiving/transmitting device 1 at each point in time.

As illustrated in FIG. 8, the control device 5 includes a communication unit 51, an acquisition unit 52, a storage unit 53, a calculation unit 54, and a display unit 55. The communication unit 51 is constituted by a communication interface. The acquisition unit 52 is constituted by a communication interface or an input interface. The storage unit 53 is constituted by, for example, a memory such as a semiconductor memory, a magnetic memory, or an optical memory. The calculation unit 54 constitutes a control unit. The control unit may be constituted by dedicated hardware such as ASIC or FPGA, may be constituted by a processor, or may include both dedicated hardware and a processor. The display unit 55 is constituted by a display interface such as a liquid crystal panel or an organic EL.

The communication unit 51 receives the movement distance information transmitted by the communication unit 43 of the traction machine 4.

The acquisition unit 52 acquires electromagnetic wave information from the information processing device 2-1. Specifically, the acquisition unit 52 may receive the electromagnetic wave information from the information processing device 2-1, or may receive, by an optional method, an input of the electromagnetic wave information received by the information processing device 2-1.

The storage unit 53 stores the movement distance information received by the communication unit 51. The storage unit 53 stores the electromagnetic wave information acquired by the acquisition unit 52.

Similarly to the calculation unit 24 of the first and second embodiments, the calculation unit 54 calculates an intensity distribution of a reflected electromagnetic wave on the basis of the intensity of the reflected electromagnetic wave and a round-trip propagation time from when the electromagnetic wave is transmitted to when the electromagnetic wave is received. Furthermore, the calculation unit 54 may calculate the intensity distribution of the electromagnetic wave also on the basis of the movement distance La by which the electromagnetic wave receiving/transmitting device 1 has been moved from the reference position in the pipeline PL by the traction machine 4.

Specifically, first, the calculation unit 54 calculates an electromagnetic wave reaching distance Lb of the reflected electromagnetic wave received at each point in time on the basis of the round-trip propagation time included in the electromagnetic wave information, similarly to the calculation unit 24 of the information processing device 2 in the first and second embodiments. Then, the calculation unit 54 calculates the intensity distribution of the electromagnetic wave, which shows the relationship among the movement distance La, the electromagnetic wave reaching distance Lb, and the intensity of the reflected electromagnetic wave, on the basis of the movement distance La at each point in time indicated by the movement distance information, and the electromagnetic wave reaching distance Lb of the reflected electromagnetic wave and the intensity of the reflected electromagnetic wave received at each point in time. For example, the calculation unit 54 may generate a distribution map DM indicating the intensity distribution of the reflected electromagnetic wave with respect to the electromagnetic wave reaching distance Lb and the movement distance La.

The display unit 55 displays the intensity distribution of the reflected electromagnetic wave calculated by the calculation unit 54. In a configuration in which the calculation unit 54 generates a distribution map DM as described above, the display unit 55 may display the distribution map DM generated by the calculation unit 54.

<Exploration Method>

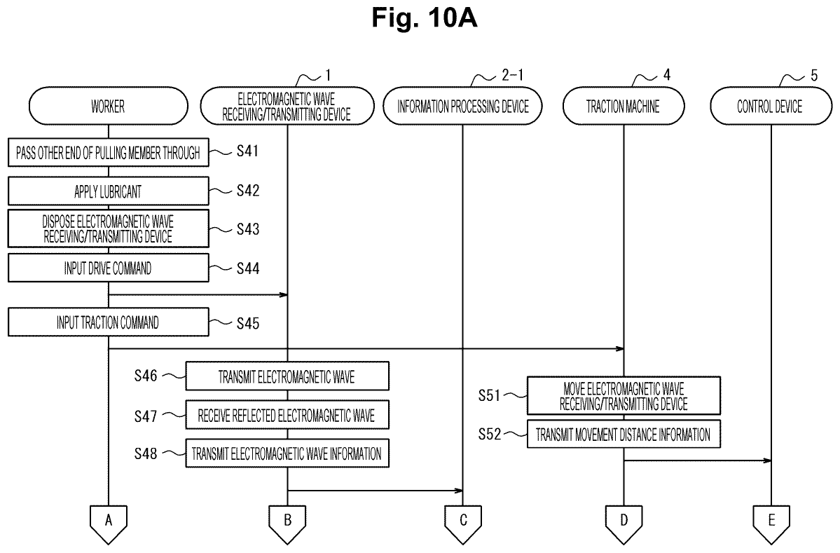

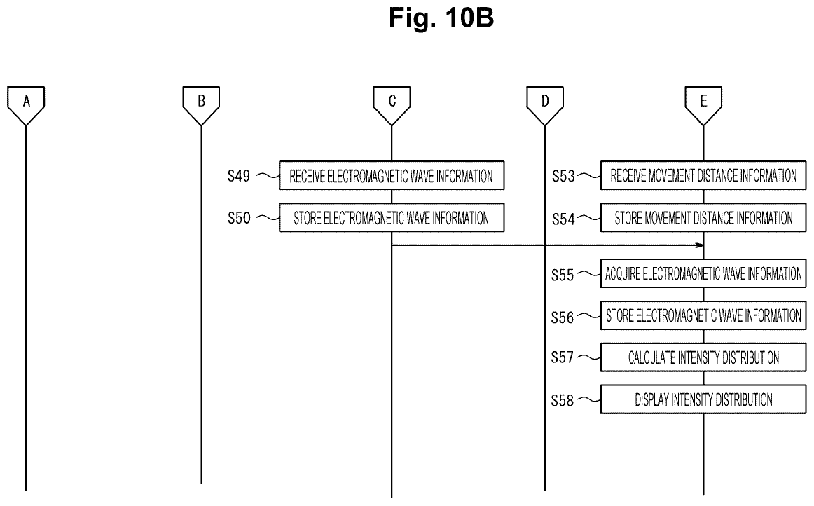

Here, an exploration method according to the third embodiment will be described with reference to FIGS. 10A and 10B. FIGS. 10A and 10B are sequence diagrams illustrating an example of the exploration method according to the third embodiment.

A worker executes the processing in steps S41 to S44. The pieces of processing in steps S41 to S44 are the same as the pieces of processing in steps S21 to S24, respectively, in the second embodiment.

In step S45, the worker inputs a traction command for the traction machine 4 to move the electromagnetic wave receiving/transmitting device 1.

When a drive command is input in step S44, the electromagnetic wave receiving/transmitting device 1 executes the processing in steps S46 to S48, and the information processing device 2-1 executes the processing in steps S49 and S50. The pieces of processing in steps S46 to S50 are the same as the pieces of processing in steps S26 to S30, respectively, in the second embodiment.

When the traction command is input in step S45, the traction machine 4 moves the electromagnetic wave receiving/transmitting device 1 at a constant velocity in the pipeline PL by pulling the pulling member 3 at a constant velocity in step S51.

In step S52, the traction machine 4 transmits, to the control device 5, movement distance information indicating the movement distance La by which the electromagnetic wave receiving/transmitting device 1 has been moved at each point in time by the traction machine 4 exerting traction on the pulling member 3.

In step S53, the control device 5 receives the movement distance information transmitted by the traction machine 4.

In step S54, the control device 5 stores the movement distance information.

When the information processing device 2-1 receives and stores electromagnetic wave information in steps S49 and S50, the control device 5 acquires the electromagnetic wave information by an optional method in step S55.

In step S56, the control device 5 stores the electromagnetic wave information.

In step S57 at an optional timing thereafter, the control device 5 calculates the intensity distribution of the electromagnetic wave. At this time, the control device 5 may generate a distribution map DM indicating the intensity distribution of the reflected electromagnetic wave.

In step S58, the control device 5 displays the intensity distribution of the electromagnetic wave. The information processing device 2-1 displays the intensity distribution of the electromagnetic wave. In a configuration in which the control device 5 generates a distribution map DM, the control device 5 may display the distribution map DM.

Note that the processing in step S42 may not be executed. Furthermore, the processing in step S41 may be executed after the processing in step S42.

As described above, according to the third embodiment, the exploration system 102 includes the traction machine 4 that moves the electromagnetic wave receiving/transmitting device 1 by exerting traction on the electromagnetic wave receiving/transmitting device 1 in the pipeline PL that allows a plurality of the manholes MH to be interconnected. The traction machine 4 can exert traction on the electromagnetic wave receiving/transmitting device 1 with a force larger than human power, and this allows the electromagnetic wave receiving/transmitting device 1 to be moved efficiently in a wider range. Thus, the exploration system 102 can identify the positions of cavities and buried objects in a wider range as compared with the exploration system 101 of the second embodiment.

According to the third embodiment, the intensity distribution of the electromagnetic wave is calculated on the basis of the movement distance information based on the control of the traction machine 4. In the third embodiment, the movement distance information is based on the control of the control device 5 for the traction machine 4 that moves the electromagnetic wave receiving/transmitting device 1, and is higher in accuracy than the movement distance information input by a worker as in the first and second embodiments. Thus, the control device 5 can calculate the intensity distribution of the electromagnetic wave with high accuracy on the basis of the movement distance information of high accuracy. Thus, the exploration system 102 can identify the position of a cavity, buried object, or the like with high accuracy.

Furthermore, according to the third embodiment, the traction machine 4 moves the electromagnetic wave receiving/transmitting device 1 at a desired velocity or a constant velocity, and this allows the control device 5 to identify, with high accuracy, the movement distance La of the electromagnetic wave receiving/transmitting device 1 from the reference position in the pipeline PL at each point in time. Thus, the control device 5 can calculate the intensity distribution of the electromagnetic wave with high accuracy on the basis of the movement distance information of high accuracy. Thus, the exploration system 102 can identify the position of a cavity, buried object, or the like with high accuracy.

Also in the third embodiment, a lubricant may be applied to a contact surface of the electromagnetic wave receiving/transmitting device 1 with the pipeline PL. This allows the traction machine 4 to move the electromagnetic wave receiving/transmitting device 1 with a smaller driving force, and reduce an operation load of the traction machine 4.

### Fourth Embodiment

<Functional Configuration of Exploration System>

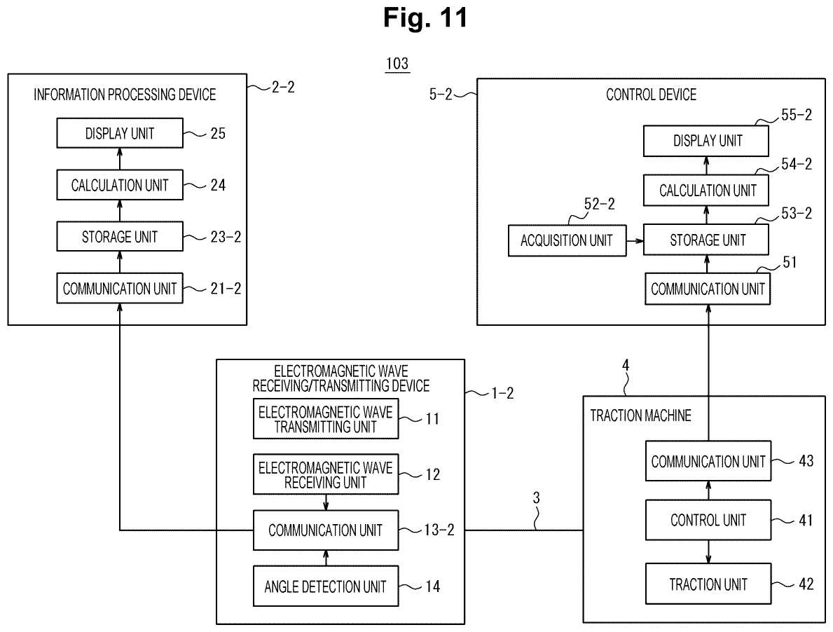

An entire configuration of a fourth embodiment will be described with reference to FIG. 11. FIG. 11 is a schematic diagram of an exploration system 103 according to the fourth embodiment. In the fourth embodiment, the same functional units as those in the third embodiment are denoted by the same reference numerals, and description thereof will be omitted.

The exploration system 103 according to the fourth embodiment includes an electromagnetic wave receiving/transmitting device 1-2, an information processing device 2-2, a pulling member 3, a traction machine 4, and a control device 5-2.

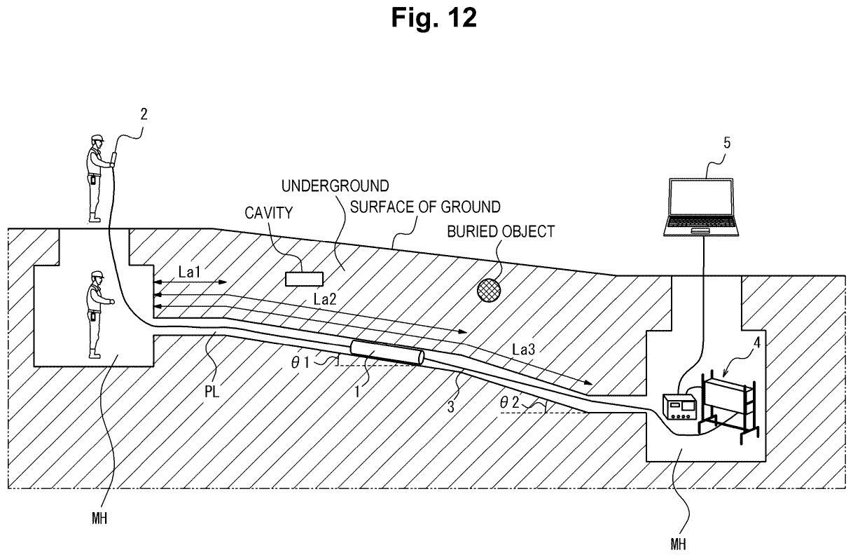

Similarly to the electromagnetic wave receiving/transmitting device 1 of the first to third embodiments, the electromagnetic wave receiving/transmitting device 1-2 transmits an electromagnetic wave and receives an electromagnetic wave that is a reflected wave of the electromagnetic wave. The electromagnetic wave receiving/transmitting device 1-2 can be a borehole radar. As illustrated in FIG. 12, the electromagnetic wave receiving/transmitting device 1-2 is disposed in a pipeline PL that is provided in the ground, allows a plurality of manholes MH to be interconnected, and has a portion inclined at an angle θ from a horizontal direction. In the example illustrated in FIG. 12, the pipeline PL has a portion extending in the horizontal direction, a portion that extends with an inclination angle θ1 from the horizontal direction, and a portion that extends with an inclination angle θ2 from the horizontal direction.

As illustrated in FIG. 11, the electromagnetic wave receiving/transmitting device 1-2 includes an electromagnetic wave transmitting unit 11, an electromagnetic wave receiving unit 12, a communication unit 13-2, and an angle detection unit 14.

The angle detection unit 14 is constituted by a sensor such as a gyro sensor. The angle detection unit 14 detects the angle θ, with respect to a horizontal plane, of a contact surface of the electromagnetic wave receiving/transmitting device 1-2 with the pipeline PL.

The communication unit 13-2 transmits, to the information processing device 2-2, electromagnetic wave information indicating the intensity of an electromagnetic wave received by the electromagnetic wave receiving unit 12 and a round-trip propagation time of the electromagnetic wave, and angle information indicating the angle θ detected by the angle detection unit 14 when the electromagnetic wave is received.

The information processing device 2-2 includes a communication unit 21-2, a storage unit 23-2, a calculation unit 24, and a display unit 25.

The communication unit 21-2 receives the electromagnetic wave information and the angle information from the communication unit 13-2 of the electromagnetic wave receiving/transmitting device 1-2 via a wired or wireless communication network.

The storage unit 23-2 stores the electromagnetic wave information and the angle information received by the communication unit 21-2.

The control device 5-2 includes a communication unit 51, an acquisition unit 52-2, a storage unit 53-2, a calculation unit 54-2, and a display unit 55-2. The acquisition unit 52-2 is constituted by a communication interface or an input interface. The storage unit 53-2 is constituted by, for example, a memory such as a semiconductor memory, a magnetic memory, or an optical memory. The calculation unit 54-2 constitutes a control unit. The control unit may be constituted by dedicated hardware such as ASIC or FPGA, may be constituted by a processor, or may include both dedicated hardware and a processor. The display unit 55-2 is constituted by a display interface such as a liquid crystal panel or an organic EL.

The acquisition unit 52-2 acquires the electromagnetic wave information and the angle information from the information processing device 2-2. Specifically, the acquisition unit 52-2 may receive the electromagnetic wave information and the angle information from the information processing device 2-2, or may receive an input of the electromagnetic wave information and the angle information received by the information processing device 2-2 by an optional method.

The storage unit 53-2 stores movement distance information received by the communication unit 51. Furthermore, the storage unit 53-2 stores the electromagnetic wave information and the angle information acquired by the acquisition unit 52-2.

The calculation unit 54-2 calculates an intensity distribution of a reflected electromagnetic wave on the basis of an intensity of the reflected electromagnetic wave and a round-trip propagation time from when the electromagnetic wave is transmitted to when the electromagnetic wave is received. Furthermore, the calculation unit 54-2 may calculate the intensity distribution of the electromagnetic wave also on the basis of a movement distance La by which the electromagnetic wave receiving/transmitting device 1-2 has been moved from a reference position in the pipeline PL. Then, the calculation unit 54-2 generates a distribution map DM indicating the intensity distribution of the reflected electromagnetic wave with respect to an electromagnetic wave reaching distance Lb and the movement distance La. The method by which the calculation unit 54-2 calculates the intensity distribution and generates the distribution map DM is the same as the method by which the calculation unit 54-2 according to the third embodiment calculates the intensity distribution and generates the distribution map DM.

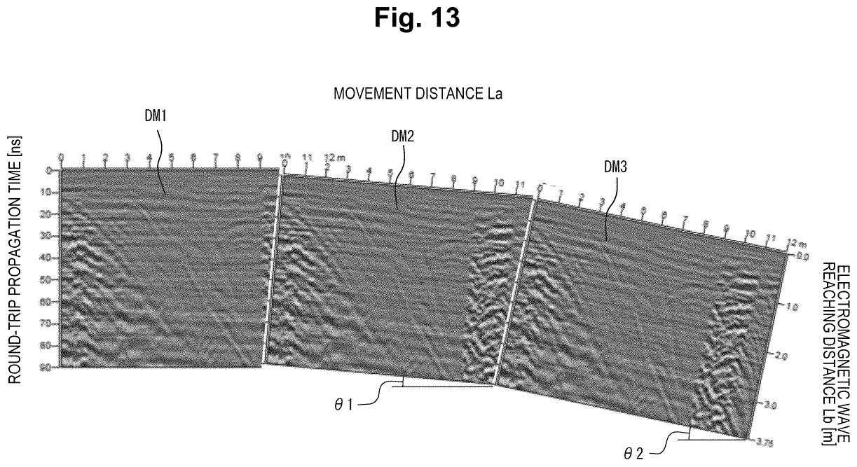

The display unit 55-2 displays the distribution map DM on the basis of the angle information. Specifically, as illustrated in FIG. 13, the display unit 55-2 displays the of the reflected electromagnetic wave corresponding to the movement distance La of the electromagnetic wave receiving/transmitting device 1-2, with the distribution map DM inclined at the angle θ corresponding to the reflected electromagnetic wave in the angle information.

In the example illustrated in FIG. 13, the display unit 55-2 displays a distribution map DM0 corresponding to the movement distance La, which is 0 or more and less than La1, with the distribution map DM0 inclined at an angle θ (not inclined). The display unit 55-2 displays a distribution map DM1 corresponding to the movement distance La, which is La1 or more and less than La2, with the distribution map DM1 inclined at the angle θ1. Similarly, the display unit 55-2 displays a distribution map DM2 corresponding to the movement distance La, which is La2 or more and less than La3, with the distribution map DM2 inclined at the angle θ2.

<Exploration Method>

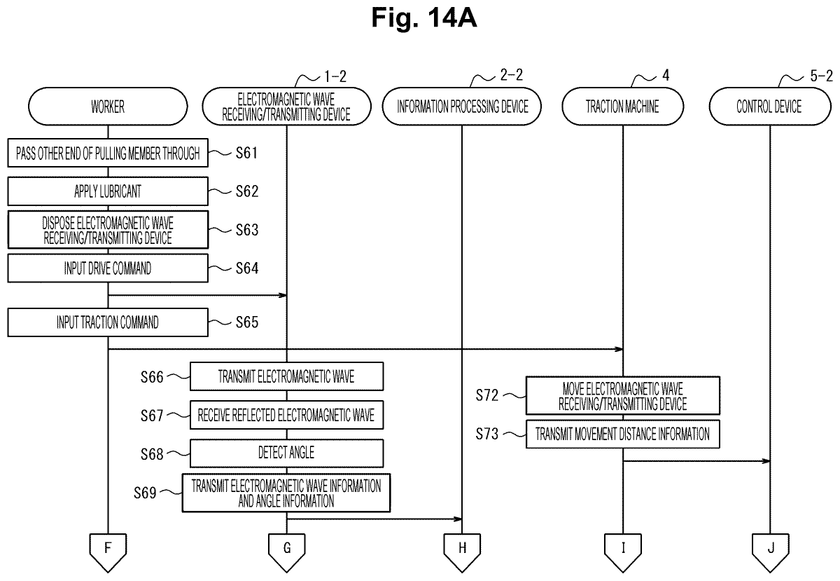

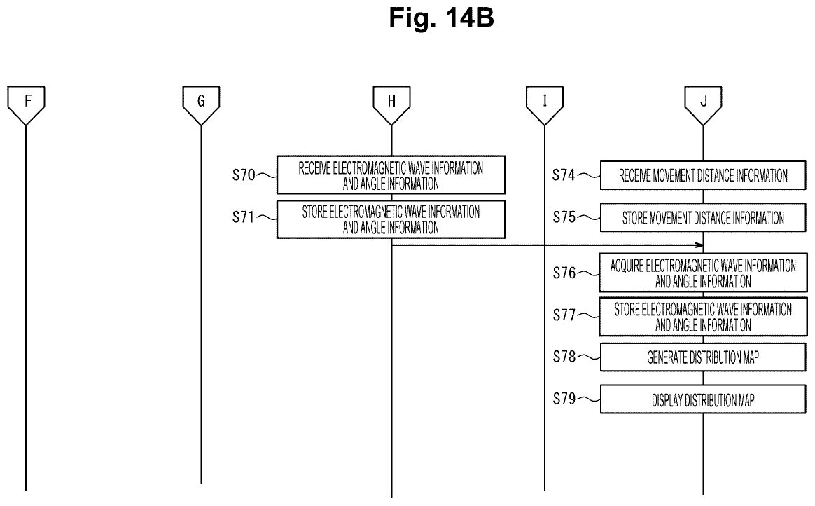

Here, an exploration method according to the fourth embodiment will be described with reference to FIGS. 14A and 14B. FIGS. 14A and 14B are sequence diagrams illustrating an example of the exploration method according to the fourth embodiment.

A worker executes the processing in steps S61 to S65. The pieces of processing in steps S61 to S65 are the same as the pieces of processing in steps S41 to S45, respectively, in the third embodiment.

When a drive command is input in step S64, the electromagnetic wave receiving/transmitting device 1-2 executes the processing in steps S66 and S67. The pieces of processing in steps S66 and S67 are the same as the pieces of processing in steps S46 and S47, respectively, in the third embodiment.

In step S68, the electromagnetic wave receiving/transmitting device 1-2 detects the angle θ, with respect to the horizontal plane, of the contact surface of the electromagnetic wave receiving/transmitting device 1-2 with the pipeline PL.

In step S69, the electromagnetic wave receiving/transmitting device 1-2 transmits electromagnetic wave information and angle information to the information processing device 2-2.

In step S70, the information processing device 2-2 receives the electromagnetic wave information and the angle information from the electromagnetic wave receiving/transmitting device 1-2.

In step S71, the information processing device 2-2 stores the electromagnetic wave information and the angle information.

Next, the traction machine 4 executes the processing in steps S72 and S73, and the control device 5-2 executes the processing in steps S74 and S75. The pieces of processing in steps S72 to S75 are the same as the pieces of processing in steps S51 to S54, respectively, in the third embodiment.

When the information processing device 2-2 receives and stores the electromagnetic wave information and the angle information in steps S70 and S71, the control device 5-2 acquires the electromagnetic wave information and the angle information by an optional method in step S76.

In step S77, the control device 5-2 stores the electromagnetic wave information and the angle information.

In step S78 at an optional timing thereafter, the control device 5-2 calculates the intensity distribution of the electromagnetic wave. Specifically, the control device 5-2 generates a distribution map DM indicating the intensity distribution of the reflected electromagnetic wave.

In step S79, the control device 5-2 displays the intensity distribution of the electromagnetic wave on the basis of the angle information. Specifically, the control device 5-2 displays the distribution map DM, with the distribution map DM inclined at the angle θ indicated by the angle information.

Note that the processing in step S62 may not be executed. Furthermore, the processing in step S61 may be executed after the processing in step S62.

As described above, according to the fourth embodiment, the electromagnetic wave receiving/transmitting device 1-2 further detects the angle θ, with respect to the horizontal plane, of the contact surface of the electromagnetic wave receiving/transmitting device 1-2 with the pipeline PL, and the information processing device 2-2 displays the electromagnetic wave information on the basis of the angle θ. Thus, also in a case where the electromagnetic wave has been measured in a state in which the electromagnetic wave receiving/transmitting device 1-2 is disposed in a direction inclined from the horizontal direction, the display unit 55-2 can display a reflection intensity distribution in a direction corresponding to the direction in a real space or a design drawing. Thus, a worker can easily identify the positions of cavities and buried objects in the real space or the design drawing.

In the fourth embodiment, in a case where the pipeline PL has ends that vary in altitude, the ends being an end on a side facing one manhole and an end on a side facing another manhole, a worker may dispose the electromagnetic wave receiving/transmitting device 1-2 by inserting the electromagnetic wave receiving/transmitting device 1-2 into the pipeline PL from the end that is higher in altitude, and the traction machine 4 may move the electromagnetic wave receiving/transmitting device 1-2 toward the end that is lower in altitude. This allows the traction machine 4 to move the electromagnetic wave receiving/transmitting device 1-2 with a smaller driving force, and reduce the operation load of the traction machine 4.

Also in the fourth embodiment, a lubricant may be applied to the contact surface of the electromagnetic wave receiving/transmitting device 1-2 with the pipeline PL. This allows the traction machine 4 to move the electromagnetic wave receiving/transmitting device 1-2 with a smaller driving force, and reduce the operation load of the traction machine 4.

<<Program>>

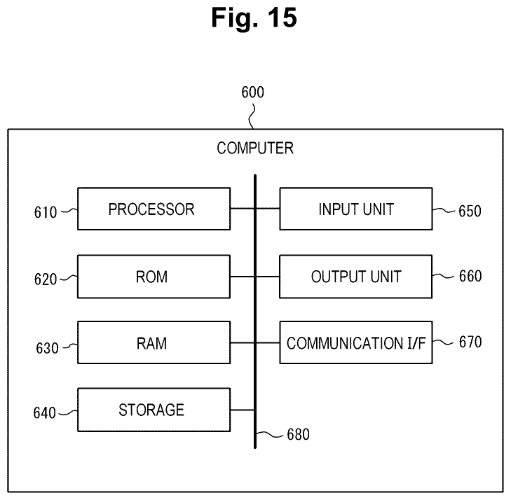

It is possible to use a computer 600 capable of executing a program instruction and cause the computer 600 to function as each of the control devices 5 and 5-2 described above. FIG. 15 is a block diagram illustrating a schematic configuration of the computer 600 that functions as each of the control devices 5 and 5-2. Here, the computer 600 may be a general-purpose computer, a dedicated computer, a workstation, a personal computer (PC), an electronic note pad, or the like. The program instruction may be a program code, code segment, or the like for executing a necessary task. It is possible to use the same computer 600 capable of executing a program instruction and cause the computer 600 to function as each of the control devices 5 and 5-2, and it is also possible to use the computers 600 capable of executing a program instruction and cause each of the computers 600 to function as one of the control devices 5 and 5-2.

<<Hardware Configuration>>

As illustrated in FIG. 15, the computer 600 includes a processor 610, a read only memory (ROM) 620, a random access memory (RAM) 630, a storage 640, an input unit 650, an output unit 660, and a communication interface (I/F) 670. The components are communicably connected to each other via a bus 680. Specifically, the processor 610 is a central processing unit (CPU), a micro processing unit (MPU), a graphics processing unit (GPU), a digital signal processor (DSP), a system on a chip (SoC), or the like and may be constituted by a plurality of processors of the same type or different types.

The processor 610 controls each component and executes various types of arithmetic processing. That is, the processor 610 reads a program from the ROM 620 or the storage 640 and executes the program by using the RAM 630 as a working area. The processor 610 controls each component described above and executes various types of arithmetic processing according to a program stored in the ROM 620 or the storage 640. In the first to fourth embodiments, a program according to the present disclosure is stored in the ROM 620 or the storage 640.

The program may be recorded in a recording medium that can be read by the computer 600. Using such a recording medium makes it possible to install the program in the computer 600. Here, the recording medium on which the program is recorded may be a non-transitory recording medium. Examples of the non-transitory recording medium may include, but are not particularly limited to, a compact disk read only memory (CD-ROM), a digital versatile disc read only memory (DVD-ROM), and a universal serial bus (USB) memory. The program may be downloaded from an external device via a network.

The ROM 620 stores various programs and various types of data. The RAM 630 temporarily stores a program or data as a working area. The storage 640 includes a hard disk drive (HDD) or a solid state drive (SSD) and stores various programs including an operating system and various types of data.

The input unit 650 includes one or more input interfaces that receive a user's input operation and acquire information based on the user's operation. Examples of the input unit 650 include, but are not limited to, a pointing device, a keyboard, and a mouse.

The output unit 660 includes one or more output interfaces that output information. For example, the output unit 660 controls, without limitation thereto, a display that outputs information as an image or a speaker that outputs information as a sound.

The communication interface 670 is an interface for communicating with another device such as an external device, and, for example, a standard such as Ethernet (registered trademark), FDDI, or Wi-Fi (registered trademark) is used.

With regard to the above embodiments, the following supplementary notes are further disclosed.

(Supplementary Note 1)

An exploration method including:
a step of disposing, in a pipeline that allows a plurality of manholes to be interconnected, an electromagnetic wave receiving/transmitting device that transmits an electromagnetic wave and receives a reflected electromagnetic wave that is a reflected wave of the electromagnetic wave;
a step of transmitting the electromagnetic wave;
a step of receiving the reflected electromagnetic wave that is the reflected wave of the electromagnetic wave; and a step of calculating an intensity distribution of the reflected electromagnetic wave on the basis of an intensity of the reflected electromagnetic wave and a round-trip propagation time from when the electromagnetic wave is transmitted to when the electromagnetic wave is received.

(Supplementary Note 2)

The exploration method according to Supplementary Note 1, further including:
a step of moving the electromagnetic wave receiving/transmitting device; and
a step of calculating the intensity distribution of the reflected electromagnetic wave also on the basis of a movement distance by which the electromagnetic wave receiving/transmitting device has been moved from a reference position in the pipeline.

(Supplementary Note 3)

The exploration method according to Supplementary Note 2, in which
the step of moving the electromagnetic wave receiving/transmitting device includes a step of moving the electromagnetic wave receiving/transmitting device by the traction machine.

(Supplementary Note 4)

An exploration system including:
an electromagnetic wave receiving/transmitting device that includes an antenna that transmits an electromagnetic wave in a pipeline that allows a plurality of manholes to be interconnected and receives a reflected electromagnetic wave that is a reflected wave of the electromagnetic wave;
a traction machine that moves the electromagnetic wave receiving/transmitting device in the pipeline; and
a control device that calculates an intensity distribution of the reflected electromagnetic wave on the basis of an intensity of the reflected electromagnetic wave and a round-trip propagation time from when the electromagnetic wave is transmitted to when the reflected electromagnetic wave is received.

(Supplementary Note 5)

The exploration system according to Supplementary Note 4, further including:
a traction machine that moves the electromagnetic wave receiving/transmitting device at a constant velocity,
in which the control device calculates the intensity distribution of the reflected electromagnetic wave also on the basis of a movement distance by which the electromagnetic wave receiving/transmitting device has been moved from a reference position in the pipeline by the traction machine.

(Supplementary Note 6)

The exploration system according to Supplementary Note 4 or 5, in which
the electromagnetic wave receiving/transmitting device further includes a sensor that detects an angle, with respect to a horizontal plane, of a contact surface of the electromagnetic wave receiving/transmitting device with the pipeline, and
the control device generates a distribution map indicating the intensity distribution.

(Supplementary Note 7)

A control device configured to calculate an intensity distribution of a reflected electromagnetic wave, on the basis of an intensity of the reflected electromagnetic wave that is a reflected wave of an electromagnetic wave transmitted from an electromagnetic wave receiving/transmitting device disposed in a pipeline that allows a plurality of manholes to be interconnected, and a round-trip propagation time from when the electromagnetic wave is transmitted to when the reflected wave of the electromagnetic wave is received.

(Supplementary Note 8)

A non-transitory storage medium storing a program that is executable by a computer, the non-transitory storage medium storing a program that causes the computer to function as the control device according to Supplementary Note 7.

All documents, patent applications, and technical standards described in the present specification are incorporated herein by reference to the same extent as in a case where each of the documents, patent applications, and technical standards has been specifically and individually described to be incorporated by reference.

Although the above-described embodiments have been described as representative examples, it is apparent to those skilled in the art that many modifications and substitutions can be made within the spirit and scope of the present disclosure. Accordingly, it should not be understood that the present invention is limited by the above-described embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1, 1-2 Electromagnetic wave receiving/transmitting device
2, 2-1, 2-2 Information processing device
3 Pulling member
4 Traction machine
5, 5-2 Control device
11 Electromagnetic wave transmitting unit
12 Electromagnetic wave receiving unit
13, 13-2 Communication unit
14 Angle detection unit
21, 21-2 Communication unit
22 Input unit
23, 23-2 Storage unit
24 Calculation unit
25 Display unit
41 Control unit
42 Traction unit
43 Communication unit
51 Communication unit
52, 52-2 Acquisition unit
53, 53-2 Storage unit
54, 54-2 Calculation unit
55, 55-2 Display unit
100, 101, 102, 103 Exploration system
600 Computer
610 Processor
620 ROM
630 RAM
640 Storage
650 Input unit
660 Output unit
670 Communication interface (I/F)
680 Bus

1. A method for exploring underground, comprising:
disposing, in a pipeline that allows a plurality of manholes to be interconnected, an electromagnetic wave receiving/transmitting device, wherein the electromagnetic wave receiving/transmitting device transmits an electromagnetic wave and receives a reflected electromagnetic wave, and the reflected electromagnetic wave includes a reflected wave of the electromagnetic wave;
transmitting the electromagnetic wave;
receiving the reflected electromagnetic wave of the electromagnetic wave; and
calculating an intensity distribution of the reflected electromagnetic wave on the basis of:
an intensity of the reflected electromagnetic wave, and
a round-trip propagation time from when the electromagnetic wave is transmitted to when the reflected electromagnetic wave is received.

2. The method according to claim 1, further comprising:
moving the electromagnetic wave receiving/transmitting device; and
calculating the intensity distribution of the reflected electromagnetic wave further on the basis of a movement distance by which the electromagnetic wave receiving/transmitting device has been moved from a reference position in the pipeline.

3. The method according to claim 2, wherein
the moving the electromagnetic wave receiving/transmitting device further comprises includes moving the electromagnetic wave receiving/transmitting device by a traction machine.

4. An exploration system comprising:
an electromagnetic wave receiving/transmitting device, wherein the electromagnetic wave receiving/transmitting device transmits an electromagnetic wave in a pipeline and receives a reflected electromagnetic wave, the pipeline interconnects a plurality of manholes, and the reflected electromagnetic wave includes a reflected wave of the electromagnetic wave; and
a control device, wherein the control device calculates an intensity distribution of the reflected electromagnetic wave on the basis of:
an intensity of the reflected electromagnetic wave, and
a round-trip propagation time from when the electromagnetic wave is transmitted to when the reflected electromagnetic wave is received.

5. The exploration system according to claim 4, further comprising:
a traction machine, wherein the traction machine moves the electromagnetic wave receiving/transmitting device at a constant velocity, and
the control device calculates the intensity distribution of the reflected electromagnetic wave further on the basis of a movement distance by which the electromagnetic wave receiving/transmitting device has been moved from a reference position in the pipeline by the traction machine.

6. The exploration system according to claim 4, wherein
the electromagnetic wave receiving/transmitting device further detects an angle of a contact surface of the electromagnetic wave receiving/transmitting device with the pipeline based on a horizontal plane, and
the control device generates a distribution map indicating the intensity distribution.

7. A control device comprising a processor configured to execute operations comprising:
calculating an intensity distribution of a reflected electromagnetic wave and a round-trip propagation time, wherein the intensity distribution of the reflected electromagnetic wave is on the basis of an intensity of the reflected electromagnetic wave, the reflected electromagnetic wave includes a reflected wave of an electromagnetic wave, the electromagnetic wave is transmitted from an electromagnetic wave receiving/transmitting device, the electromagnetic wave receiving/transmitting device is disposed in a pipeline, the pipeline interconnects a plurality of manholes, and the round-trip propagation time indicates a time lapse from when the electromagnetic wave is transmitted to when the reflected wave of the electromagnetic wave is received.

8. (canceled)

9. The method according to claim 1, wherein the pipeline is located underground.

10. The method according to claim 1, wherein the transmitting the electromagnetic wave further comprises transmitting the electromagnetic wave from underground.

11. The method according to claim 1, wherein the receiving the electromagnetic wave further comprises receiving the reflected electromagnetic wave underground.

12. The method according to claim 2, wherein the moving the electromagnetic wave receiving/transmitting device further comprising moving the electromagnetic wave receiving/transmitting device inside the pipeline underground by using a traction machine.

13. The exploration system according of claim 4, wherein the pipeline is located underground.

14. The exploration system according of claim 4, wherein the electromagnetic wave receiving/transmitting device transmits the electromagnetic wave from underground.

15. The exploration system according of claim 4, wherein the electromagnetic wave receiving/transmitting device receives the reflected electromagnetic wave underground.

16. The exploration system according of claim 5, wherein
the electromagnetic wave receiving/transmitting device further detects an angle of a contact surface of the electromagnetic wave receiving/transmitting device with the pipeline based on a horizontal plane, and
the control device generates a distribution map indicating the intensity distribution.

17. The control device according to claim 7, wherein the pipeline is located underground.

18. The control device according to claim 7, wherein the electromagnetic wave receiving/transmitting device is located underground.

19. The control device according to claim 7, the processor further configured to execute operations comprising:
transmitting a control signal for moving the electromagnetic wave receiving/transmitting device inside the pipeline at a constant velocity; and
receiving data associated with the electromagnetic wave.

20. The control device according to claim 7, the processor further configured to execute operations comprising:
receiving first data indicating a movement distance of the electromagnetic wave receiving/transmitting device inside the pipeline; and
receiving second data associated with the reflected electromagnetic wave.

21. The control device according to claim 20, the processor further configured to execute operations comprising:
displaying the intensity distribution of the reflected electromagnetic wave according to the data indicating the movement distance of the electromagnetic wave receiving/transmitting device.
